(19) United States
(12) Patent Application Publication
(10) Pub. No.: US 2024/0397968 A1
(43) Pub. Date: Dec. 5, 2024

(54) AGENT FOR IMPARTING ANIMAL-FAT CONSISTENCY, OIL AND FAT COMPOSITION FOR IMPARTING ANIMAL-FAT CONSISTENCY, METHOD FOR IMPARTING ANIMAL-FAT CONSISTENCY, METHOD FOR PRODUCING AGENT FOR IMPARTING ANIMAL-FAT CONSISTENCY, AND FOOD PRODUCT TO WHICH ANIMAL-FAT CONSISTENCY IS IMPARTED

(71) Applicant: J-OIL MILLS, INC., Tokyo (JP)

(72) Inventors: Mika NISHIWAKI, Tokyo (JP); Chie MOTOIKE, Tokyo (JP); Yoshiko NARA, Tokyo (JP); Hisamichi FUJII, Tokyo (JP)

(21) Appl. No.: 18/694,746

(22) PCT Filed: Dec. 7, 2022
(86) PCT No.: PCT/JP2022/045067

§ 371 Date: Mar. 22, 2024

(30) Foreign Application Priority Data
Dec. 16, 2021 (JP) 2021-204194

(51) Int. Cl. A23D 9/02

(52) U.S. Cl. CPC A23D 9/02

(57) ABSTRACT

There is provided: an agent for imparting an animal-fat consistency, characterized in that an oxidized oil and fat that is not derived from animals is used as an active ingredient; an agent for imparting an animal-fat consistency, characterized in that a product obtained by enzymatically hydrolyzing an oxidized oil and fat that is not derived from animals is used as an active ingredient; an oil and fat composition for imparting an animal-fat consistency, characterized by containing an edible oil and fat that serves as a base oil, and an oxidized oil and fat that is not derived from animals; and an oil and fat composition for imparting an animal-fat consistency, characterized by containing an edible oil and fat that serves as a base oil, and a product obtained by enzymatically hydrolyzing an oxidized oil and fat that is not derived from animals.

### TECHNICAL FIELD

The present invention relates to technology for imparting an animal-fat consistency to a food product.

### BACKGROUND ART

In recent years, there has tended to be an increase in the number of people who avoid eating specific types of meat due to religious reasons or people who abstain from eating meat in response to trends for healthier lifestyles. Soybean raw materials have been used to develop meat-free hamburgers, etc. However, a problem is presented in that such food products lack a meat-like flavor.

In relation to technology for imparting a meat-like flavor to food products, for example, Patent Document 1 indicates that (Z)-8-pentadecenal, which is detected as a volatile component from cucumbers, is used in an agent for imparting and enhancing a heat-cooked-meat-like flavor.

Additionally, for example, Patent Document 2 discloses a food product in which a meat-product flavor is reproduced upon cooking, the food product containing: a) a 0.1% to 1% (w/v) heme-containing protein; b) a sugar, a sugar alcohol, a sugar acid, or a sugar derivative selected from glucose, ribose, fructose, lactose, xylose, arabinose, glucose 6-phosphate, maltose, galactose, and compounds of two or more of these sugars; c) a compound selected from cysteine, cystine, selenocysteine, thiamine, and compounds of two or more of these compounds; and d) one or a plurality of plant proteins.

Moreover, for example, Patent Document 3 relates to technology for improving the flavor of a plant-protein-containing composition and indicates that using a processed tomato product that is prepared by being heat-treated masks any unpleasant plant-protein-derived odor (protein odor) while suppressing any ingredient odor that is characteristic of tomatoes (e.g., paragraph).

### RELATED ART DOCUMENTS

### Patent Documents

Patent Document 1: U.S. Pat. No. 5,868,811
Patent Document 2: U.S. Pat. No. 6,553,516
Patent Document 3: Japanese Laid-open Patent Application No. 2019-71851

### DISCLOSURE OF THE INVENTION

### Problems the Invention is Intended to Solve

However, in recent years, consumers' interest in food has steadily increased, and there has been a demand to develop even more ingredients that are capable of imparting an animal-fat consistency similar to that when meat is used, even to food products that contain no meat or a reduced amount of meat.

It is accordingly an object of the present invention to provide an exceptional ingredient that is capable of imparting an animal-fat consistency to a food product.

### Means for Solving the Aforementioned Problems

As a result of thoroughgoing investigations, the inventors discovered that implementing a specific treatment on an oil and fat yields an ingredient having an exceptional effect for imparting an animal-fat consistency, thereby perfecting the present invention.

Specifically, according to a first aspect, the present invention provides an agent for imparting an animal-fat consistency, characterized in that an oxidized oil and fat that is not derived from animals is used as an active ingredient.

In the agent for imparting an animal-fat consistency according to the first aspect of the present invention, the oxidized oil and fat is preferably obtained by oxidizing at least one oil and fat selected from rapeseed oil, soybean oil, sunflower oil, rice bran oil, corn oil, red palm oil, grapeseed oil, macadamia nut oil, and coconut oil.

According to a second aspect, the present invention provides an agent for imparting an animal-fat consistency, characterized in that a product obtained by enzymatically hydrolyzing an oxidized oil and fat that is not derived from animals is used as an active ingredient.

In the agent for imparting an animal-fat consistency according to the second aspect of the present invention, the oxidized oil and fat is preferably obtained by oxidizing at least one oil and fat selected from rapeseed oil, soybean oil, sunflower oil, rice bran oil, corn oil, red palm oil, grapeseed oil, macadamia nut oil, and coconut oil.

According to a third aspect, the present invention provides an oil and fat composition for imparting an animal-fat consistency, characterized by containing an edible oil and fat that serves as a base oil, and an oxidized oil and fat that is not derived from animals.

In the oil and fat composition for imparting an animal-fat consistency according to the third aspect of the present invention, the oxidized oil and fat is preferably obtained by oxidizing at least one oil and fat selected from rapeseed oil, soybean oil, sunflower oil, rice bran oil, corn oil, red palm oil, grapeseed oil, macadamia nut oil, and coconut oil.

According to a fourth aspect, the present invention provides an oil and fat composition for imparting an animal-fat consistency, characterized by containing an edible oil and fat that serves as a base oil, and a product obtained by enzymatically hydrolyzing an oxidized oil and fat that is not derived from animals.

In the oil and fat composition for imparting an animal-fat consistency according to the fourth aspect of the present invention, the oxidized oil and fat is preferably obtained by oxidizing at least one oil and fat selected from rapeseed oil, soybean oil, sunflower oil, rice bran oil, corn oil, red palm oil, grapeseed oil, macadamia nut oil, and coconut oil.

According to a fifth aspect, the present invention provides a method for imparting an animal-fat consistency, characterized in that the aforementioned agent for imparting an animal-fat consistency, or the aforementioned oil and fat composition for imparting an animal-fat consistency, is incorporated into a food product.

In the method for imparting an animal-fat consistency according to the fifth aspect of the present invention, the aforementioned agent for imparting an animal-fat consistency, or the aforementioned oil and fat composition for imparting an animal-fat consistency, is preferably added and incorporated such that the amount of the oxidized oil and fat that is not derived from animals is 0.0001 parts by mass or greater and 10 parts by mass or less per 100 parts by mass of the food product.

Additionally, in the method for imparting an animal-fat consistency according to the fifth aspect of the present invention, the aforementioned agent for imparting an animal-fat consistency, or the aforementioned oil and fat composition for imparting an animal-fat consistency, is preferably added and incorporated such that the amount of the product obtained by enzymatically hydrolyzing the oxidized oil and fat that is not derived from animals is 0.0001 parts by mass or greater and 10 parts by mass or less per 100 parts by mass of the food product.

According to a sixth aspect, the present invention provides
a method for producing an agent for imparting an animal-fat consistency, characterized by including
a step for oxidizing an oil and fat that is not derived from animals to obtain an oxidized oil and fat.

In the method for producing an agent for imparting an animal-fat consistency according to the sixth aspect of the present invention, the oxidized oil and fat is preferably obtained by oxidizing at least one oil and fat selected from rapeseed oil, soybean oil, sunflower oil, rice bran oil, corn oil, red palm oil, grapeseed oil, macadamia nut oil, and coconut oil.

According to a seventh aspect, the present invention provides
a method for producing an agent for imparting an animal-fat consistency, characterized by including
a step for oxidizing an oil and fat that is not derived from animals to obtain an oxidized oil and fat, and
a step for hydrolyzing the oxidized oil and fat by an enzyme to obtain a hydrolysate.

In the method for producing an agent for imparting an animal-fat consistency according to the seventh aspect of the present invention, the oxidized oil and fat is preferably obtained by oxidizing at least one oil and fat selected from rapeseed oil, soybean oil, sunflower oil, rice bran oil, corn oil, red palm oil, grapeseed oil, macadamia nut oil, and coconut oil.

Additionally, in the method for producing an agent for imparting an animal-fat consistency according to the seventh aspect of the present invention, a lipase is preferably used as the enzyme.

Additionally, in the method for producing an agent for imparting an animal-fat consistency according to the sixth or seventh aspect of the present invention, the oxidation treatment is preferably performed by applying heat while supplying oxygen to the oil and fat.

According to an eighth aspect, the present invention provides a food product containing an oxidized oil and fat that is not derived from animals, the food product having an animal-fat consistency imparted thereto by the oxidized oil and fat.

In the food product having an animal-fat consistency imparted thereto according to the eighth aspect of the present invention, the oxidized oil and fat is preferably obtained by oxidizing at least one oil and fat selected from rapeseed oil, soybean oil, sunflower oil, rice bran oil, corn oil, red palm oil, grapeseed oil, macadamia nut oil, and coconut oil.

Additionally, in the food product having an animal-fat consistency imparted thereto according to the eighth aspect of the present invention, the food product is preferably a processed-meat-like food product that does not contain any meat raw materials, a processed-meat food product, or a processed-meat-stock-soup-like food product.

According to a ninth aspect, the present invention provides a food product containing a product obtained by enzymatically hydrolyzing an oxidized oil and fat that is not derived from animals, the food product having an animal-fat consistency imparted thereto by the product obtained by enzymatically hydrolyzing an oxidized oil and fat.

In the food product having an animal-fat consistency imparted thereto according to the ninth aspect of the present invention, the oxidized oil and fat is preferably obtained by oxidizing at least one oil and fat selected from rapeseed oil, soybean oil, sunflower oil, rice bran oil, corn oil, red palm oil, grapeseed oil, macadamia nut oil, and coconut oil.

Additionally, in the food product having an animal-fat consistency imparted thereto according to the ninth aspect of the present invention, the food product is preferably a processed-meat-like food product that does not contain any meat raw materials, a processed-meat food product, or a processed-meat-stock-soup-like food product.

### [Impossible/Impractical Circumstances]

In the present invention, an oil and fat is oxidized, or if necessary is furthermore enzymatically hydrolyzed, and the resulting oil and fat is used as an active ingredient for imparting an animal-fat consistency. Generally, products obtained by treating oils and fats are compositions configured from exceedingly numerous types of chemical substances, and it is impossible to investigate and fully identify the contained chemical substances, or else it is impractical to do so due to requiring considerably excessive financial expenses and time.

### Effect of the Invention

According to the present invention, using a product obtained by treating an oil and fat makes it possible to provide an exceptional ingredient that is capable of imparting an animal-fat consistency to a food product.

### BEST MODE FOR CARRYING OUT THE INVENTION

In the present invention, an oil and fat is subjected to a specific treatment, and the resulting oil and fat is used in imparting an animal-fat consistency to a food product. Specifically, the treatment includes an oxidation treatment and an enzymatic hydrolysis treatment. The form in which the present invention is realized is described in greater detail below.

There is no particular limitation as to the oil and fat serving as a raw material in the oxidation treatment, provided that the oil and fat can be consumed. However, the oil and fat is preferably at least one selected from rapeseed oil, soybean oil, sunflower oil, rice bran oil, corn oil, red palm oil, grapeseed oil, macadamia nut oil, and coconut oil. The extent of oxidation is preferably such that, insofar as the peroxide value of a commercially distributed edible oil and fat is typically about 0-10, the peroxide value is raised to about 15 or higher and 300 or lower, where peroxide value is used as an index. The range of the peroxide value (also referred to below as “POV”) may be 25 or higher and 290 or lower, 40 or higher and 270 or lower, or 60 or higher and 250 or lower, according to other aspects. If the peroxide value is below the abovementioned range, the effect for imparting an animal-fat consistency will tend to be poor. If the peroxide value exceeds the abovementioned range, there is a concern that flavor will worsen. The POV can be measured in conformance with “Standard methods for the analysis of fats, oils and related materials: 2.5.2 Peroxide value” (Japan Oil Chemists' Society). One type of oil and fat supplied to the oxidation treatment may be used alone, or two or more types of oils and fats may be used in combination. In cases where two or more types of oils and fats are used in combination, the peroxide value of the entire oil mixture after the oxidation treatment is to be within the abovementioned range. The two or more types of oils and fats may be individually oxidized and then mixed, and the peroxide value of the entire oil mixture obtained by mixing after the oxidation treatment is to be within the abovementioned range.

There is no particular limitation as to the enzymatic hydrolysis treatment, provided that an esterified form of a glycerol fatty acid or another fatty acid contained in the oxidized oil and fat is subjected to enzymatic hydrolysis and the fatty acid is isolated, whereby the fatty acid content rises. However, it is preferable for a lipase to be used as the enzyme. The extent of hydrolysis is preferably such that, insofar as the acid value of a commercially distributed edible oil and fat is typically about 0-1, the acid value is raised to about 5 or higher and 200 or lower, where acid value is used as an index, the acid value reflecting the amount of the isolated fatty acid contained in the oil and fat. The range of the acid value (also referred to below as “AV”) may be 10 or higher and 190 or lower, 20 or higher and 180 or lower, or 30 or higher and 170 or lower, according to other aspects. If the acid value is below the abovementioned range, the effect for imparting an animal-fat consistency will tend to be poor. If the acid value exceeds the abovementioned range, there is a concern that the flavor will worsen. The AV can be measured in conformance with “Standard methods for the analysis of fats, oils and related materials: 2.3.1 Acid value” (Japan Oil Chemists' Society). One type of oxidized oil and fat supplied to the enzymatic hydrolysis treatment may be used alone, or two or more types of oxidized oils and fats may be used in combination. In cases where two or more types of oxidized oils and fats are used in combination, the acid value of the entire oil mixture after the hydrolysis treatment is to be within the abovementioned range. The two or more types of oils and fats may be individually hydrolyzed using an enzyme and then mixed, and the AV of the entire oil mixture obtained by mixing after the hydrolysis treatment is to be within the abovementioned range.

There is no particular limitation as to the method for oxidizing the oil and fat, provided that it is thereby possible to carry out the oxidation treatment to reach a peroxide value (POV) within the prescribed range. Preferred examples include methods that involve heating treatments. For example, from the standpoint of production on an industrial scale, it is preferable that, once the raw-material oil and fat is accommodated in a tank or another suitable container, the oxidation treatment is carried out using a heating means provided to the container, the heating means heating the raw-material oil and fat via, e.g., thermoelectric conversion, direct-flame burners, microwaves, steam, or hot blasts of air.

An oil and fat such as rapeseed oil, soybean oil, sunflower oil, rice bran oil, corn oil, red palm oil, grapeseed oil, macadamia nut oil, or coconut oil is to be used as the raw-material oil and fat that is subjected to the oxidation treatment, as described above. One type of raw-material oil and fat supplied to the oxidation treatment may be used alone, or two or more types of raw-material oils and fats may be used in combination. In cases where raw-material oils and fats are used in combination, an oil mixture may be supplied to the oxidation treatment, or the raw-material oils and fats may be individually oxidized and then mixed.

There is no particular limitation as to the conditions of the heating treatment. However, the heating treatment is preferably carried out at a heating temperature of 50° C. or higher and 220° C. or lower for a heating time of 0.1 hours or more and 240 hours or less, and more preferably carried out at a heating temperature of 60° C. or higher and 160° C. or lower for a heating time of 1 hour or more and 100 hours or less. The value of an integrated amount represented by (heating temperature (° C.))×(heating time (hours)) is typically 200 or greater and 20,000 or less; the range of this value may be 220 or greater and 18,000 or less, or 240 or greater and 15,000 or less, according to other aspects. In cases where the heating temperature is changed, the value of the integrated amount represented by (heating temperature (° C.))×(heating time (hours)) can be calculated as (heating temperature before change in temperature (° C.))×(heating time before change in temperature (hours))+ (heating temperature after change in temperature (° C.))×(heating time after change in temperature (hours)), or as an integral value of the heating temperature (° C.) over the heating time (hours).

In the heating treatment, oxygen (air) may be supplied by taking in oxygen from an open space in the container through stirring or by blowing in oxygen. Air or the like may be used as an oxygen source. Oxidation of the oil and fat is thereby promoted. In such instances, the amount of oxygen supplied is preferably 0.001-2 L/min per kilogram of the oil and fat. For example, when air is used as the oxygen source, the amount of air supplied is preferably 0.005-10 L/min, and more preferably 0.01-5 L/min, per kilogram of the oil and fat.

There is no particular limitation as to the method for carrying out the enzymatic hydrolysis treatment, provided that it is thereby possible to carry out the hydrolysis treatment to reach an acid value (AV) within the prescribed range using the abovementioned oxidized oil and fat as a raw material. However, preferred examples include methods in which a lipase is used as the enzyme. There is no particular limitation as to the lipase used, provided that the lipase is derived from, e.g., any source from among microorganisms, animals, and plants. However, it is preferable to use a lipase derived from microorganisms. Examples of the microorganisms include filamentous fungi (Aspergillus awamori, Aspergillus niger, Aspergillus oryzae, Aspergillus phoenicis, Aspergillus usamii, Geotrichum candidum, Humicola, Mucor javanicus, Mucor miehei, Penicillium camemberti, Penicillium chrysogenum, Penicillum roqueforti, Rhizomucor miehei, Rhizopus delemar, Rhizopus japonicus, Rhizomucor miehei, Rhizopus niveus, or Rhizopus oryzae), actinomycetes (Streptomyces), bacteria (Alcaligenes, Arthrobactor, Chromobacterium viscosum, Pseudomonas, or Serratia marcescens), and yeasts (Candida). It is preferable to use a lipase derived from microorganisms of genus Candida.

One type of enzyme may be used alone, or two or more types of enzymes may be used in combination. In cases where two or more types of enzymes are used in combination, the plurality of types of enzymes may be added simultaneously into a reaction system; alternatively, the plurality of types of enzymes may be added sequentially, such as when one of the enzymes is added and applied to a reaction, after which another enzyme is added after completion of the previous reaction and applied to a subsequent reaction.

Conditions such as temperature, pH, and reaction time suited to the enzyme being used are to be selected, as appropriate, as the reaction conditions for the enzymatic hydrolysis. In cases where, for example, a lipase is used, the temperature is typically to be set such that the lipase does not deactivate; the range of the temperature may be 20° C. or higher and 70° C. or lower, 25° C. or higher and 60° C. or lower, or 30° C. or higher and 50° C. or lower, according to other aspects. The reaction time is to be, e.g., 0.05 hours or more and 120 hours or less; the range of the reaction time may be 0.1 hours or more and 72 hours or less, 0.2 hours or more and 48 hours or less, or 0.3 hours or more and 30 hours or less, according to other aspects. The amount of enzyme added relative to the oxidized oil and fat is to be, e.g., 0.001 mass % or greater and 40 mass % or less; the range of the added amount may be 0.005 mass % or greater and 30 mass % or less, 0.01 mass % or greater and 20 mass % or less, or 0.05 mass % or greater and 10 mass % or less, according to other aspects.

Typically, in reactions for enzymatic hydrolysis, the reaction will tend to occur more efficiently when a given amount of water is present. Thus, the hydrolysis treatment may be carried out once a prescribed amount of water is added. In such instances, the amount of water added is preferably 10 parts by mass or greater and 1,000 parts by mass or less, more preferably 20 parts by mass or greater and 800 parts by mass or less, even more preferably 40 parts by mass or greater and 600 parts by mass or less, and yet even more preferably 60 parts by mass or greater and 500 parts by mass or less per 100 parts by mass of the oxidized oil and fat.

After the enzymatic hydrolysis treatment, a treatment to deactivate the enzyme may be carried out if desired. The treatment to deactivate the enzyme is preferably carried out using a heating treatment at 25-110° C. for about one minute to two hours. It is also preferable that centrifugation is carried out in order to separate an oil layer and a water layer, and that the oil layer is recovered. It is furthermore preferable to add fresh water to the recovered oil layer, rinse the oil layer using the water, carry out centrifugation to again separate an oil layer and a water layer, and recover the oil layer again. Water-soluble impurities are thereby removed from the oil layer.

The abovementioned oxidized oil and fat (also referred to below simply as the “oxidized oil and fat”), or the product obtained by enzymatically hydrolyzing the oxidized oil and fat (also referred to below simply as the “hydrolysate”), has an exceptional effect for imparting an animal-fat consistency to a food product as indicated in the examples below. Thus, the oxidized oil and fat or the hydrolysate in the present invention is used as an active ingredient of an agent for imparting an animal-fat consistency.

According to a discretionary non-limiting aspect of the present invention, the agent for imparting an animal-fat consistency may be provided in the form of an oil and fat composition. Specifically, the agent for imparting an animal-fat consistency can be an oil and fat composition that is obtained by blending, e.g., an edible oil and fat, a diluent, an adjuvant, an emulsifier, a pH adjuster, or the like as necessary and that takes the form of a liquid, a powder, a paste, or any other form through a well-known method. More specifically, for example, the agent for imparting an animal-fat consistency may be prepared as a liquid oil and fat, a margarine, a fat spread, a shortening, a powdered oil and fat, or the like that is mainly composed of an oil and fat component, or alternatively may be prepared as a solution, a powder, a gel, a granulated product, or the like that contains a small blending amount of the oil and fat component, by using a formulation technique that is well known to ordinary persons skilled in the art; these forms may be employed in a discretionary manner. Additionally, in cases such as when the agent for imparting an animal-fat consistency is powderized, it is possible to use corn syrup or another adjuvant, and it is furthermore permissible to add an emulsifier to prepare an emulsified raw material and then powderize the emulsified raw material. Examples of means for powderization include spray drying and freeze drying.

Examples of the edible oil and fat include: rapeseed oil (including high-oleic-acid rapeseed oil), soybean oil, palm oil, palm kernel oil, corn oil, olive oil, sesame oil, safflower oil, sunflower oil, cottonseed oil, rice bran oil, peanut oil, coconut oil, cacao butter, and other vegetable oils and fats; beef tallow, pig lard, chicken fat, milkfat, and other animal oils and fats; and medium-chain fatty-acid triglycerides. Additional examples include fractionated oils (medium-melting-point fractionated palm oil, softened fractionated palm oil, hardened fractionated palm oil, etc.), trans-esterified oils, hydrogenated oils, and other processed oils and fats obtained from the abovementioned oils and fats. One type of edible oil and fat may be used alone, or two or more types of edible oils and fats may be mixed together. However, from the standpoint of targeting a food product that is free of animal raw materials, it is preferable to avoid using animal oils and fats.

In the agent for imparting an animal-fat consistency that is provided by the present invention, auxiliary agents that are ordinarily added to foods may be blended as appropriate within a range in which the desired animal-fat-consistency-imparting performance is not hindered. Examples of the auxiliary agents include antioxidants, antifoaming agents, emulsifiers, fragrances, flavor-imparting agents, pigments, and biologically active substances. Specific examples include ascorbic acid fatty-acid esters, lignan, coenzyme-Q, γ-oryzanol, tocopherol, and silicone.

The amount of the abovementioned oxidized oil and fat contained in the agent for imparting an animal-fat consistency is not particularly limited. However, the oxidized oil and fat content is preferably 0.01 mass % or higher and 10 mass % or lower, more preferably 0.03 mass % or higher and 7 mass % or lower, and even more preferably 0.05 mass % or higher and 5 mass % or lower. The ingredient that provides the abovementioned oxidized oil and fat may constitute the agent for imparting an animal-fat consistency.

The amount of the product obtained by hydrolyzing the abovementioned oxidized oil and fat using an enzyme contained in the agent for imparting an animal-fat consistency is not particularly limited. However, the hydrolysate content is preferably 0.01 mass % or higher and 10 mass % or lower, more preferably 0.03 mass % or higher and 7 mass % or lower, and even more preferably 0.05 mass % or higher and 5 mass % or lower. The ingredient that provides the product obtained by enzymatically hydrolyzing the abovementioned oxidized oil and fat may constitute the agent for imparting an animal-fat consistency.

According to another non-limiting aspect of the present invention, the abovementioned oxidized oil and fat or the product obtained by enzymatically hydrolyzing the oxidized oil and fat may be incorporated into an edible oil and fat. Specifically, there is provided an oil and fat composition for imparting an animal-fat consistency that contains an edible oil and fat serving as a base oil and either the oxidized oil and fat or the hydrolysate. Providing such a composition makes it easier to adjust the concentration of the oxidized oil and fat or the hydrolysate, using the edible oil and fat as a dispersion medium, and also facilitates thorough spreading of the oxidized oil and fat or the hydrolysate into a food, a raw-material ingredient, a food product component, or the like when the oxidized oil and fat or the hydrolysate is incorporated into a food or beverage product.

In the same manner as with the abovementioned agent for imparting an animal-fat consistency, examples of the edible oil and fat include: rapeseed oil (including high-oleic-acid rapeseed oil), soybean oil, palm oil, palm kernel oil, corn oil, olive oil, sesame oil, safflower oil, sunflower oil, cottonseed oil, rice bran oil, peanut oil, coconut oil, cacao butter, and other vegetable oils and fats; beef tallow, pig lard, chicken fat, milkfat, and other animal oils and fats; and medium-chain fatty-acid triglycerides. Additional examples include fractionated oils (medium-melting-point fractionated palm oil, softened fractionated palm oil, hardened fractionated palm oil, etc.), trans-esterified oils, hydrogenated oils, and other processed oils and fats obtained from the abovementioned oils and fats. One type of edible oil and fat may be used alone, or two or more types of edible oils and fats may be mixed together. However, from the standpoint of targeting a food product that is free of animal raw materials, it is preferable to avoid using animal oils and fats.

The amount of the edible oil and fat and the amount of the oxidized oil and fat or the hydrolysate contained in the oil and fat composition for imparting an animal-fat consistency are not particularly limited, but preferably yield a state in which the oxidized oil and fat or the hydrolysate is satisfactorily dispersed in the oil and fat composition. For example, the edible oil and fat content is preferably 90 mass % or higher and 99.99 mass % or lower, more preferably 93 mass % or higher and 99.97 mass % or lower, and even more preferably 95 mass % or higher and 99.95 mass % or lower. The oxidized oil and fat content is preferably 0.01 mass % or higher and 10 mass % or lower, more preferably 0.03 mass % or higher and 7 mass % or lower, and even more preferably 0.05 mass % or higher and 5 mass % or lower. The hydrolysate content is preferably 0.01 mass % or higher and 10 mass % or lower, more preferably 0.03 mass % or higher and 7 mass % or lower, and even more preferably 0.05 mass % or higher and 5 mass % or lower. The content ratio of the oxidized oil and fat to the edible oil and fat is preferably 0.01 parts by mass or greater and 11.12 parts by mass or less, more preferably 0.03 parts by mass or greater and 7.53 parts by mass or less, and even more preferably 0.05 parts by mass or greater and 5.27 parts by mass or less per 100 parts by mass of the edible oil and fat. The content ratio of the hydrolysate to the edible oil and fat is preferably 0.01 parts by mass or greater and 11.12 parts by mass or less, more preferably 0.03 parts by mass or greater and 7.53 parts by mass or less, and even more preferably 0.05 parts by mass or greater and 5.27 parts by mass or less per 100 parts by mass of the edible oil and fat. According to other aspects, there may be cases where the oxidized oil and fat or the hydrolysate is a solid or the like at normal temperature; therefore, the oxidized oil and fat or the hydrolysate may be mixed with the edible oil and fat in a state of being sufficiently melted through heating or the like.

In the oil and fat composition for imparting an animal-fat consistency that is provided by the present invention, auxiliary agents that are ordinarily added to foods may be blended as appropriate within a range in which the desired animal-fat-consistency-imparting performance is not hindered. Examples of the auxiliary agents include antioxidants, antifoaming agents, emulsifiers, fragrances, flavor-imparting agents, pigments, and biologically active substances. Specific examples include ascorbic acid fatty-acid esters, lignan, coenzyme-Q, γ-oryzanol, tocopherol, and silicone.

The present invention is applied to a food product and is to be used for imparting an animal-fat consistency to the food product. Imparting an “animal-fat consistency” is defined in the same manner as would ordinarily be understood by a person skilled in the art and specifically includes imparting a flavor or taste that is experienced with animal oils and fats such as lard, beef tallow, and chicken oil. More specifically, this term refers to the possibility of imparting a meat-like flavor even to food products that contain no meat, as well as to the possibility of sufficiently imparting a meat-like flavor to a food product irrespective of whether the food product contains a reduced amount of meat. Even more specifically, this term includes imparting features that are experienced with lard, such as aroma, spreading of flavor, richness in substance and aftertaste, thick fatty consistency, and persistence of aftertaste, but is not limited thereto. This term also includes imparting features that are experienced with beef tallow, such as sweet fatty flavor, richness in substance and aftertaste, thick fatty consistency that remains in the mouth after consumption, and persistence of aftertaste. This term also includes imparting features that are experienced with chicken oil, such as aroma, richness in substance and aftertaste, and persistence of aftertaste. If deterioration, loss, or another form of decline in flavor in distributed heating, microwave heating, or the like is an issue, this term includes preventing such circumstances or alleviating the issue. Furthermore, this term includes masking a characteristic taste, odor, off-flavor, or the like that is derived from the raw material of the food product to which the present invention is applied to achieve a taste that is more desirable to consumers.

The food product to which the present invention is applied may be, e.g., a processed-meat-like food product that does not contain any meat raw materials. Specifically, the processed-meat-like food product is obtained by replacing a meat raw material in a processed-meat food product that ordinarily contains a meat raw material with, inter alia, a soybean protein or another vegetable protein. Specific examples of the processed-meat-like food product include: hamburgers, meatballs, meat sauces, meat dumplings, sausages, steamed dumplings, gyoza, meat cutlets, minced cutlets, chicken nuggets, meat-filled steamed buns, Chinese-style dumplings, and other meat-filled foods; bouillon soup; and ramen soup, in which a meat raw material is replaced with a raw material other than the meat raw material. Additionally, the food product to which the present invention is applied may be, e.g., a processed-meat food product in which a meat raw material is contained. Similarly to the processed-meat-like food product, examples of the processed-meat food product include: hamburgers, meatballs, meat sauces, meat dumplings, sausages, steamed dumplings, gyoza, meat cutlets, minced cutlets, chicken nuggets, meat-filled steamed buns, Chinese-style dumplings, and other meat-filled foods; bouillon soup; and ramen soup. In such instances, it is preferable that part of the meat raw material is replaced with, inter alia, a soybean protein or another vegetable protein, whereby the meat raw material content will be lower than normal.

When the present invention is applied to a food product, there is no particular limitation as to the form in which the present invention is used. For example, the present invention can be introduced into a raw material of a food product, or an intermediate article in a step for producing the food product, through adding, mixing, coating, dissolving, dispersing, emulsifying, or injection at a discretionary timing, thereby imparting an animal-fat consistency to the resulting food product. Additionally, not only may the present invention be added to a raw material or a production-step intermediate article, but also the food product can be sprinkled or coated with the present invention after having been prepared, processed, or produced, whereby the present invention is added to the food product. Furthermore, the present invention may be used by being incorporated into a release oil, a rice-cooking oil, a frying oil, a stir-frying oil, or another cooking oil, or a thickening oil, an oil for injection, a finishing oil, or another seasoning oil, in the preparation, processing, or production of the food product, whereby the present invention is added to the food product. If deterioration, loss, or another form of decline in flavor in distributed heating, microwave heating, or the like is an issue, the present invention can also be suitably used in a processed distributed food product including, inter alia, a processed frozen food product, a processed refrigerated food product, a retort food product, a bottled food product, a canned food product, a dried food product, a packaged meal and the like.

The use state of the abovementioned agent for imparting an animal-fat consistency or oil and fat composition for imparting an animal-fat consistency shall be described in further detail here. In the present invention, the oxidized oil and fat or the hydrolysate contained in the agent or the composition is to be used by being incorporated into the food product or the raw material therefor. An animal-fat consistency can thereby be imparted to the food product. The amount added to the food product is to be set as appropriate in accordance with the type of food product being applied. Typically, for example, the amount of the oxidized oil and fat in the form of the food product to which the present invention is applied is preferably 1 mass ppm or greater and 1,000 mass ppm or less. The range of the oxidized oil and fat content may be 2 mass ppm or greater and 800 mass ppm or less, 3 mass ppm or greater and 500 mass ppm or less, or 5 mass ppm or greater and 200 mass ppm or less, according to other aspects. Additionally, the amount of the hydrolysate is preferably 1 mass ppm or greater and 1,000 mass ppm or less. The range of the hydrolysate content may be 2 mass ppm or greater and 800 mass ppm or less, 3 mass ppm or greater and 500 mass ppm or less, or 5 mass ppm or greater and 200 mass ppm or less, according to other aspects.

According to a discretionary non-limiting aspect of the present invention, a substance prepared by adding the oxidized oil and fat or the hydrolysate and a substance prepared in a similar manner without adding the oxidized oil and fat or the hydrolysate are supplied to a sensory evaluation test, preferably a sensory evaluation test conducted by a plurality of panelists who are selected so as to have no preferential bias relative to a statistical population, whereby it is possible to objectively evaluate whether an animal-fat consistency has been imparted to the food product to which the present invention is applied.

The scope of the food product to which the present invention can be applied is not limited to uses for humans; the present invention can also be applied to feed or fodder for animals.

### EXAMPLES

The present invention is described more specifically below through examples, but these examples in no way limit the scope of the present invention.

Table 1 shows the materials used in the test.

TABLE 1

| | Material | Manufacturer/product name, etc. |
|---|---|---|
| Raw-material | Rapeseed oil | J-Oil Mills, Inc., “AJINOMOTO sarasara canola oil” |
| oil and fat | Soybean oil | J-Oil Mills, Inc., “AJINOMOTO rich and tasty soybean oil” |
| | Sunflower oil | J-Oil Mills, Inc., “High-oleic sunflower oil” |
| | Rice bran oil | J-Oil Mills, Inc., “Rice bran oil” |
| | Corn oil | J-Oil Mills, Inc., “AJINOMOTO cereal blessing corn oil” |
| | Red palm oil | Carotino (CAROTINO SDN BHD), “Carotino pure olein” |
| | Grapeseed oil | J-Oil Mills, Inc., “AJINOMOTO healthy grapeseed oil” |
| | Macadamia nut oil | Summit Oil Mill Co., Ltd., “Macadamia nut oil” |
| | Coconut oil | Kao Corp., “Refined coconut oil RCO” |
| Enzyme | Lipase | Amano Enzyme Inc., Lipase AY “Amano” 30SD |
| Base oil | Rapeseed oil | J-Oil Mills, Inc., “AJINOMOTO sarasara canola oil” |
| | Soybean oil | J-Oil Mills, Inc., “AJINOMOTO rich and tasty soybean oil” |
| Animal fat | Lard | Maruzen Foods Corp., “mz Lard S” |
| | Beef tallow | Maruzen Foods Corp., “mz Beef oil A” |
| | Chicken oil | Ariake Japan Co., Ltd., “Chi-yu” |
| Other | Bouillon | Nestlé Japan Ltd., “Maggi additive-free bouillon: Free of 27 allergens” |
| | Soybean protein | J-Oil Mills, Inc., “Plantxt M-14” |
| | Soybean protein | J-Oil Mills, Inc., “Plantxt F-16” |
| | Soybean protein | Fuji Oil Co., Ltd., “Apex 110” |
| | Soybean protein | Fuji Oil Co., Ltd., “Apex 950” |
| | Dried egg whites | Kewpie Egg Corp. |
| | Shortening | J-Oil Mills, Inc., “PB fat” |
| | Tempura powder | Showa Sangyo Co., Ltd., “Gold” |

### Preparation Example 1

### (1. Oxidized Oil and Fat)

An oil and fat in an amount of 200-500 g was introduced into a beaker, and a heating treatment was carried out on the oil and fat under the temperature and time conditions shown in table 2 under stirring at a stirring speed of 200-400 rpm in an oil bath while air was supplied thereto in an amount of 0.20-0.50 L/min. The peroxide value (POV) of the resulting oxidized oil and fat was measured in conformance with “Standard methods for the analysis of fats, oils and related materials: 2.5.2 Peroxide value.”

Table 2 shows the conditions of the oxidation treatment carried out on the oils and fats as well as the results of measuring the POV of the resulting oxidized oils and fats.

TABLE 2
(Oxidation treatment conditions)

| | | | | | | Peroxide |
|---|---|---|---|---|---|---|
| Type of | Amount | | | | Stirring | value (POV) |
| raw-material | contained | Temperature | Time | Air flow | speed | of treated |
| oil and fat | (g) | (° C.) | (h) | (mL/min) | (rpm) | oil and fat |
| Rapeseed oil | 200 | 100 | 19 | 200 | 200 | 133.0 |
| Soybean oil | 200 | 100 | 17 | 200 | 200 | 151.1 |
| Sunflower oil | 500 | 103 | 36 | 500 | 400 | 116.0 |
| Rice bran oil | 200 | 100 | 24 | 200 | 200 | 108.0 |
| Corn oil | 200 | 100 | 18 | 200 | 200 | 101.1 |
| Red palm oil | 240 | 103 | 40 | 200 | 200 | 115.0 |
| Grapeseed oil | 200 | 100 | 12 | 200 | 200 | 104.0 |
| Macadamia | 450 | 103 | 29 | 450 | 400 | 108.1 |
| nut oil | | | | | | |
| Coconut oil | 450 | 120 | 35 | 450 | 400 | 118.0 |

### (2. Hydrolysate)

A hydrolysis treatment carried out using a lipase was implemented on the resulting oxidized oil and fat. Specifically, 20 g of the oxidized oil and fat, 12 g of water, and the lipase (in an amount of 0.2 g, 0.08 g, or 0.04 g) were introduced into a 50-mL tube, the lid of the tube was closed, the tube was placed in a thermostatic oven set to 40° C., and a hydrolysis treatment carried out using the lipase was implemented under the time conditions shown in table 3 under shaking at a stirring speed of 150 rpm. After a reaction time elapsed, the tube was retrieved from the thermostatic oven and centrifuged (at 3,000 rpm for 5 min) at 24° C., and 10-15 g of an upper layer (oil layer) was harvested. The harvested treated product was introduced into a stoppered tube, dipped in an oil bath, and treated for one hour at 80° C. in order to deactivate the enzyme. The acid value of the resulting lipase-treated product was measured in conformance with “Standard methods for the analysis of fats, oils and related materials: 2.3.1 Acid value” (Japan Oil Chemists' Society).

Table 3 shows the conditions of the lipase treatment carried out on the oxidized oils and fats as well as the results of measuring the acid value of the resulting treated products.

TABLE 3
(Enzyme treatment conditions)

| Type of oxidized | Amount of | | | |
|---|---|---|---|---|
| oil and fat | enzyme added | | | Acid value |
| supplied to | to oxidized | Temperature | Time | of treated |
| treatment | oil and fat | (° C.) | (h) | oil and fat |
| Rapeseed oil | 1% | 40 | 0.5 | 143.8 |
| Soybean oil | 1% | 40 | 1.5 | 158.7 |
| Sunflower oil | 0.2% | 40 | 5.0 | 103.1 |
| Rice bran oil | 1% | 40 | 0.5 | 151.0 |
| Corn oil | 1% | 40 | 0.5 | 181.7 |
| Red palm oil | 1% | 40 | 0.45 | 116.0 |
| Grapeseed oil | 1% | 40 | 0.5 | 142.0 |
| Macadamia | 0.4% | 40 | 1.5 | 86.9 |
| nut oil | | | | |
| Coconut oil | 0.4% | 40 | 2.5 | 67.8 |

### Test Example 1

The effect of the various types of treated oils (preparation example 1) for imparting a lardy consistency to plant-based bouillon soup was evaluated. Specifically, a sensory evaluation was conducted as described below.

The oil and fat was either left untreated or subjected to the various types of treatments, and then was added to and mixed into rapeseed oil serving as a base oil, in an amount of 1 mass %, to prepare a test oil. The test oil was added to and mixed into plant-based bouillon soup (product name “Maggi additive-free bouillon: Free of 27 allergens”, made by Nestlé Japan Ltd.) so as to reach an amount of 0.5 mass % to obtain bouillon soup in which the final concentration of the sample (untreated oil, or various types of treated oils) was 50 mass ppm. In the sensory evaluation, from the standpoint of lardy consistency (lard flavor), and more specifically from the standpoint of features that are experienced with lard, such as aroma, spreading of flavor, richness in substance and aftertaste, or thickness, the resulting bouillon soup was rated using the scoring criteria below by three expert panelists in a comparison with a product obtained when lard was added and mixed so as to reach an amount of 0.5 mass % without being diluted, and an average value of the scores for the bouillon soup was derived.

### (Samples)

Untreated: Oil and fat prior to oxidation treatment.
Oxidation treatment: Oil and fat after oxidation treatment.
Oxidation and lipase treatments: Oil and fat obtained by furthermore implementing lipase treatment on oxidized oil and fat

### (Scores)

0: Flavor equivalent to that when no test oil is added
1: Slightly more lard flavor than when no test oil is added
2: Moderately more lard flavor than when no test oil is added
3: More lard flavor than when no test oil is added
4: Clearly more lard flavor than when no test oil is added
5: Strong lard flavor but not quite equivalent
6: Flavor equivalent to that when lard is added
(Scored at intervals of 0.5 points in cases involving intermediate evaluations between the abovementioned scores)

Table 4 shows the results of the sensory evaluation.

TABLE 4
(Evaluation of lardy consistency)

| Test oil | | Evaluation | | | |
|---|---|---|---|---|---|
| Raw-material | | Panelist | Panelist | Panelist | |
| oil and fat | Treatment | 1 | 2 | 3 | Average |
| Rapeseed oil | Untreated | 0 | 0 | 0 | 0.0 |
| | Oxidation | 1 | 1.5 | 1.5 | 1.3 |
| | Oxidation and | 2 | 3 | 3 | 2.7 |
| | lipase | | | | |
| Soybean oil | Untreated | 0 | 0 | 0 | 0.0 |
| | Oxidation | 2 | 2 | 1 | 1.7 |
| | Oxidation and | 3.5 | 3 | 2 | 2.8 |
| | lipase | | | | |
| Sunflower oil | Untreated | 0 | 0 | 0 | 0.0 |
| | Oxidation | 2.5 | 3 | 2 | 2.5 |
| | Oxidation and | 3.5 | 3.5 | 3.5 | 3.5 |
| | lipase | | | | |
| Rice bran oil | Untreated | 0 | 0 | 0 | 0.0 |
| | Oxidation | 2 | 2 | 2 | 2.0 |
| | Oxidation and | 3 | 3 | 3 | 3.0 |
| | lipase | | | | |
| Corn oil | Untreated | 0 | 0 | 0 | 0.0 |
| | Oxidation | 1.5 | 2.5 | 2 | 2.0 |
| | Oxidation and | 2.5 | 3 | 3.5 | 3.0 |
| | lipase | | | | |
| Red palm oil | Untreated | 0 | 0 | 0 | 0.0 |
| | Oxidation | 2 | 2.5 | 2 | 2.2 |
| | Oxidation and | 3 | 3 | 3 | 3.0 |
| | lipase | | | | |
| Grapeseed oil | Untreated | 0 | 0 | 0 | 0.0 |
| | Oxidation | 1 | 2 | 1 | 1.3 |
| | Oxidation and | 2 | 3 | 2 | 2.3 |
| | lipase | | | | |
| Macadamia | Untreated | 0 | 0 | 0 | 0.0 |
| nut oil | Oxidation | 3 | 3.5 | 3 | 3.2 |
| | Oxidation and | 4 | 4 | 4 | 4.0 |
| | lipase | | | | |
| Coconut oil | Untreated | 0 | 0 | 0 | 0.0 |
| | Oxidation | 2.5 | 3 | 2.5 | 2.7 |
| | Oxidation and | 4 | 3.5 | 4 | 3.8 |
| | lipase | | | | |

As indicated by the results of the sensory evaluation in the upper sections for each of the oils and fats in table 4, adding the untreated oils and fats did not yield an effect for imparting a lardy consistency. However, as indicated by the results of the sensory evaluation in the central sections for each of the oils and fats in table 4, it was clarified that the oxidized oils and fats obtained by implementing the prescribed oxidation treatment have an effect for imparting a lardy consistency, more specifically an effect for imparting a lard flavor to plant-based bouillon soup. Additionally, as indicated by the results of the sensory evaluation in the lower sections for each of the oils and fats in table 4, it was clarified that furthermore implementing the lipase treatment on the oxidized oils and fats prepared using the oils and fats as raw materials further improved the effect for imparting a lardy consistency to plant-based bouillon soup over the effect of the oxidized oils and fats that were subjected to only the oxidation treatment.

### Test Example 2

The effect of the various types of treated oils (preparation example 1) for imparting a beef-tallow consistency to plant-based bouillon soup was evaluated. Specifically, a sensory evaluation was conducted as described below.

The oil and fat was either left untreated or subjected to the various types of treatments, and then was added to and mixed into rapeseed oil serving as a base oil, in an amount of 1 mass %, to prepare a test oil. The test oil was added to and mixed into plant-based bouillon soup (product name “Maggi additive-free bouillon: Free of 27 allergens”, made by Nestlé Japan Ltd.) so as to reach an amount of 0.5 mass % to obtain bouillon soup in which the final concentration of the sample (untreated oil, or various types of treated oils) was 50 mass ppm. In the sensory evaluation, from the standpoint of beef-tallow consistency (beef-tallow flavor), and more specifically from the standpoint of features that are experienced with beef tallow, such as sweet fatty flavor, richness in substance and aftertaste, or thick fatty consistency that remains in the mouth after consumption, the resulting bouillon soup was rated using the scoring criteria below by three expert panelists in a comparison with a product obtained when beef tallow was added and mixed so as to reach an amount of 0.5 mass % without being diluted, and an average value of the scores for the bouillon soup was derived.

### (Samples).

Untreated: Oil and fat prior to oxidation treatment.
Oxidation treatment: Oil and fat after oxidation treatment
Oxidation and lipase treatments: Oil and fat obtained by furthermore implementing lipase treatment on oxidized oil and fat

### (Scores)

0: Flavor equivalent to that when no test oil is added
1: Slightly more beef tallow flavor than when no test oil is added
2: Moderately more beef tallow flavor than when no test oil is added
3: More beef tallow flavor than when no test oil is added
4: Clearly more beef tallow flavor than when no test oil is added
5: Strong beef tallow flavor but not quite equivalent
6: Flavor equivalent to that when beef tallow is added
(Scored at intervals of 0.5 points in cases involving intermediate evaluations between the abovementioned scores)

Table 5 shows the results of the sensory evaluation.

TABLE 5
(Evaluation of beef-tallow consistency)

| Test oil | | Evaluation | | | |
|---|---|---|---|---|---|
| Raw-material | | Panelist | Panelist | Panelist | |
| oil and fat | Treatment | 1 | 2 | 3 | Average |
| Rapeseed oil | Untreated | 0 | 0 | 0 | 0.0 |
| | Oxidation | 0.5 | 1 | 1.5 | 1.0 |
| | Oxidation and | 1.5 | 3 | 2.5 | 2.3 |
| | lipase | | | | |
| Soybean oil | Untreated | 0 | 0 | 0 | 0.0 |
| | Oxidation | 1.5 | 1.5 | 1 | 1.2 |
| | Oxidation and | 2.5 | 2.5 | 2 | 2.3 |
| | lipase | | | | |
| Sunflower oil | Untreated | 0 | 0 | 0 | 0.0 |
| | Oxidation | 2 | 2 | 1.5 | 1.8 |
| | Oxidation and | 3 | 3.5 | 3 | 3.2 |
| | lipase | | | | |
| Rice bran oil | Untreated | 0 | 0 | 0 | 0.0 |
| | Oxidation | 1.5 | 2 | 1 | 1.5 |
| | Oxidation and | 2 | 3 | 2.5 | 2.5 |
| | lipase | | | | |
| Corn oil | Untreated | 0 | 0 | 0 | 0.0 |
| | Oxidation | 1 | 2 | 1 | 1.3 |
| | Oxidation and | 2 | 3 | 2 | 2.3 |
| | lipase | | | | |
| Red palm oil | Untreated | 0 | 0 | 0 | 0.0 |
| | Oxidation | 1.5 | 1 | 1.5 | 1.3 |
| | Oxidation and | 2.5 | 2.5 | 2 | 2.3 |
| | lipase | | | | |
| Grapeseed oil | Untreated | 0 | 0 | 0 | 0.0 |
| | Oxidation | 0.5 | 1 | 1.5 | 1.0 |
| | Oxidation and | 1.5 | 2 | 2.5 | 2.0 |
| | lipase | | | | |
| Macadamia | Untreated | 0 | 0 | 0 | 0.0 |
| nut oil | Oxidation | 2.5 | 2 | 2 | 2.2 |
| | Oxidation and | 3.5 | 3.5 | 3.5 | 3.5 |
| | lipase | | | | |
| Coconut oil | Untreated | 0 | 0 | 0 | 0.0 |
| | Oxidation | 2 | 2 | 2.5 | 2.2 |
| | Oxidation and | 3 | 3 | 4 | 3.3 |
| | lipase | | | | |

As indicated by the results of the sensory evaluation in the upper sections for each of the oils and fats in table 5, adding the untreated oils and fats did not yield an effect for imparting a beef-tallow consistency. However, as indicated by the results of the sensory evaluation in the central sections for each of the oils and fats in table 5, it was clarified that the oxidized oils and fats obtained by implementing the prescribed oxidation treatment have an effect for imparting a beef-tallow consistency, more specifically an effect for imparting a beef-tallow flavor to plant-based bouillon soup. Additionally, as indicated by the results of the sensory evaluation in the lower sections for each of the oils and fats in table 5, it was clarified that furthermore implementing the lipase treatment on the oxidized oils and fats prepared using the oils and fats as raw materials further improved the effect for imparting a beef-tallow consistency to plant-based bouillon soup over the effect of the oxidized oils and fats that were subjected to only the oxidation treatment.

### Test Example 3

The effect of the various types of treated oils (preparation example 1) for imparting a chicken-oil consistency to plant-based bouillon soup was evaluated. Specifically, a sensory evaluation was conducted as described below.

The oil and fat was either left untreated or subjected to the various types of treatments, and then was added to and mixed into rapeseed oil serving as a base oil, in an amount of 1 mass %, to prepare a test oil. The test oil was added to and mixed into plant-based bouillon soup (product name “Maggi additive-free bouillon: Free of 27 allergens”, made by Nestlé Japan Ltd.) so as to reach an amount of 0.5 mass % to obtain bouillon soup in which the final concentration of the sample (untreated oil, or various types of treated oils) was 50 mass ppm. In the sensory evaluation, from the standpoint of chicken-oil consistency (chicken-oil flavor), and more specifically from the standpoint of features that are experienced with chicken oil, such as aroma, richness in substance and aftertaste, or persistence of aftertaste, the resulting bouillon soup was rated using the scoring criteria below by three expert panelists in a comparison with a product obtained when chicken oil was added and mixed so as to reach an amount of 0.5 mass % without being diluted, and an average value of the scores for the bouillon soup was derived.

### (Samples).

Untreated: Oil and fat prior to oxidation treatment.
Oxidation treatment: Oil and fat after oxidation treatment
Oxidation and lipase treatments: Oil and fat obtained by furthermore implementing lipase treatment on oxidized oil and fat

### (Scores)

0: Flavor equivalent to that when no test oil is added
1: Slightly more chicken oil flavor than when no test oil is added
2: Moderately more chicken oil flavor than when no test oil is added
3: More chicken oil flavor than when no test oil is added
4: Clearly more chicken oil flavor than when no test oil is added
5: Strong chicken oil flavor but not quite equivalent
6: Flavor equivalent to that when chicken oil is added
(Scored at intervals of 0.5 points in cases involving intermediate evaluations between the abovementioned scores)

Table 6 shows the results of the sensory evaluation.

TABLE 6
(Evaluation of chicken-oil consistency)

| Test oil | | Evaluation | | | |
|---|---|---|---|---|---|
| Raw-material | | Panelist | Panelist | Panelist | |
| oil and fat | Treatment | 1 | 2 | 3 | Average |
| Rapeseed oil | Untreated | 0 | 0 | 0 | 0.0 |
| | Oxidation | 1 | 1 | 1.5 | 1.2 |
| | Oxidation and | 2 | 2 | 2.5 | 2.2 |
| | lipase | | | | |
| Soybean oil | Untreated | 0 | 0 | 0 | 0.0 |
| | Oxidation | 1.5 | 1 | 1.5 | 1.3 |
| | Oxidation and | 2.5 | 2 | 2.5 | 2.3 |
| | lipase | | | | |
| Sunflower oil | Untreated | 0 | 0 | 0 | 0.0 |
| | Oxidation | 2.5 | 1 | 1.5 | 1.7 |
| | Oxidation and | 3.5 | 3 | 3 | 3.2 |
| | lipase | | | | |
| Rice bran oil | Untreated | 0 | 0 | 0 | 0.0 |
| | Oxidation | 1.5 | 1 | 1.5 | 1.3 |
| | Oxidation and | 2.5 | 2.5 | 2.5 | 2.5 |
| | lipase | | | | |
| Corn oil | Untreated | 0 | 0 | 0 | 0.0 |
| | Oxidation | 1 | 1.5 | 1 | 1.2 |
| | Oxidation and | 2 | 3 | 2 | 2.3 |
| | lipase | | | | |
| Red palm oil | Untreated | 0 | 0 | 0 | 0.0 |
| | Oxidation | 1.5 | 1 | 1.5 | 1.3 |
| | Oxidation and | 2.5 | 1.5 | 2 | 2.0 |
| | lipase | | | | |
| Grapeseed oil | Untreated | 0 | 0 | 0 | 0.0 |
| | Oxidation | 1 | 1 | 1 | 1.0 |
| | Oxidation and | 2 | 2 | 2 | 2.0 |
| | lipase | | | | |
| Macadamia | Untreated | 0 | 0 | 0 | 0.0 |
| nut oil | Oxidation | 2.5 | 2 | 1.5 | 2.0 |
| | Oxidation and | 3.5 | 2.5 | 2.5 | 2.8 |
| | lipase | | | | |
| Coconut oil | Untreated | 0 | 0 | 0 | 0.0 |
| | Oxidation | 2.5 | 2 | 2 | 2.2 |
| | Oxidation and | 3.5 | 2.5 | 2.5 | 2.8 |
| | lipase | | | | |

As indicated by the results of the sensory evaluation in the upper sections for each of the oils and fats in table 6, adding the untreated oils and fats did not yield an effect for imparting a chicken-oil consistency. However, as indicated by the results of the sensory evaluation in the central sections for each of the oils and fats in table 6, it was clarified that the oxidized oils and fats obtained by implementing the prescribed oxidation treatment have an effect for imparting a chicken-oil consistency, more specifically an effect for imparting a chicken-oil flavor to plant-based bouillon soup. Additionally, as indicated by the results of the sensory evaluation in the lower sections for each of the oils and fats in table 6, it was clarified that furthermore implementing the lipase treatment on the oxidized oils and fats prepared using the oils and fats as raw materials further improved the effect for imparting a chicken-oil consistency to plant-based bouillon soup over the effect of the oxidized oils and fats that were subjected to only the oxidation treatment.

### Preparation Example 2

### (1. Oxidized Oil and Fat)

A heating treatment was carried out on sunflower oil or macadamia nut oil under the temperature and time conditions shown in table 7 under stirring at a stirring speed of 400 rpm. The peroxide value (POV) of the resulting oxidized oil and fat was measured in conformance with “Standard methods for the analysis of fats, oils and related materials: 2.5.2 Peroxide value.”

Table 7 shows the conditions of the oxidation treatment carried out on the oils and fats as well as the results of measuring the POV of the resulting oxidized oils and fats.

TABLE 7
(Oxidation treatment conditions)

| | | | | | | | Peroxide |
|---|---|---|---|---|---|---|---|
| Type of | | Amount | | | | Stirring | value (POV) |
| raw-material | | contained | Temperature | Time | Air flow | speed | of treated |
| oil and fat | Expression | (g) | (° C.) | (h) | (mL/min) | (rpm) | oil and fat |
| Sunflower | Oxidized oil | 450 | 103 | 34 | 450 | 400 | 36.5 |
| oil | and fat 1 | | | | | | |
| | Oxidized oil | 450 | 103 | 35.5 | 450 | 400 | 57.1 |
| | and fat 2 | | | | | | |
| | Oxidized oil | 450 | 103 | 36 | 450 | 400 | 116.0 |
| | and fat 3 | | | | | | |
| | Oxidized oil | 450 | 103 | 37 | 450 | 400 | 188.0 |
| | and fat 4 | | | | | | |
| Macadamia | Oxidized oil | 450 | 103 | 27 | 450 | 400 | 32.2 |
| nut oil | and fat 5 | | | | | | |
| | Oxidized oil | 450 | 103 | 28 | 450 | 400 | 60.0 |
| | and fat 6 | | | | | | |
| | Oxidized oil | 450 | 103 | 29 | 450 | 400 | 108.1 |
| | and fat 7 | | | | | | |
| | Oxidized oil | 450 | 103 | 30 | 450 | 400 | 189.2 |
| | and fat 8 | | | | | | |

### (2. Hydrolysate)

A hydrolysis treatment carried out using a lipase was implemented on the resulting oxidized oil and fat. Specifically, 20 g of the oxidized oil and fat, 12 g of water, and the lipase (in an amount of 0.08 g or 0.04 g) were introduced into a 50-mL tube, the lid of the tube was closed, the tube was placed in a thermostatic oven set to 40° C., and a hydrolysis treatment carried out using the lipase was implemented under the time conditions shown in table 8 under shaking at a stirring speed of 150 rpm. After a reaction time elapsed, the tube was retrieved from the thermostatic oven and centrifuged (at 3,000 rpm for 5 min) at 24° C., and 10-15 g of an upper layer (oil layer) was harvested. The harvested treated product was introduced into a stoppered tube, dipped in an oil bath, and treated for one hour at 80° C. in order to deactivate the enzyme. The acid value of the resulting lipase-treated product was measured in conformance with “Standard methods for the analysis of fats, oils and related materials: 2.3.1 Acid value” (Japan Oil Chemists' Society).

Table 8 shows the conditions of the lipase treatment carried out on the oxidized oils and fats as well as the results of measuring the acid value of the resulting treated products.

TABLE 8
(Enzyme treatment conditions)

| | | Amount | | | |
|---|---|---|---|---|---|
| | Oxidized oil | of enzyme | | | |
| Type of raw- | and fat | added to | Temper- | | Acid value |
| material | supplied to | oxidized | ature | Time | of treated |
| oil and fat | treatment | oil and fat | (° C.) | (h) | oil and fat |
| Sunflower | Oxidized oil | 0.2% | 40 | 2.0 | 105.0 |
| oil | and fat 1 | | | | |
| | Oxidized oil | 0.2% | 40 | 2.0 | 96.6 |
| | and fat 2 | | | | |
| | Oxidized oil | 0.2% | 40 | 5.0 | 103.1 |
| | and fat 3 | | | | |
| | Oxidized oil | 0.4% | 40 | 2.0 | 96.3 |
| | and fat 4 | | | | |
| Macadamia | Oxidized oil | 0.2% | 40 | 3.0 | 95.9 |
| nut oil | and fat 5 | | | | |
| | Oxidized oil | 0.2% | 40 | 4.0 | 100.4 |
| | and fat 6 | | | | |
| | Oxidized oil | 0.4% | 40 | 1.5 | 86.9 |
| | and fat 7 | | | | |
| | Oxidized oil | 0.4% | 40 | 2.0 | 93.3 |
| | and fat 8 | | | | |

### Test Example 4

The effect for imparting a lardy consistency to plant-based bouillon soup was examined in the same manner as in test example 1, except that the oxidized oils and fats 1 to 4 and the products obtained by lipase-treating the same, which were prepared in preparation example 2, were used as samples. The final concentration of the samples in the plant-based bouillon soup was 50 ppm, in the same manner as in test example 1.

Table 9 shows the results of the sensory evaluation.

TABLE 9
(Evaluation of lardy consistency)

| Raw-material oil and fat: sunflower oil | | | | Evaluation | | | |
|---|---|---|---|---|---|---|---|
| | Amount | | | Panelist | Panelist | Panelist | |
| Treatment | added | POV | AV | 1 | 2 | 3 | Average |
| Untreated | 50 ppm | — | — | 0 | 0 | 0 | 0.0 |

| | | | | Evaluation | | | |
|---|---|---|---|---|---|---|---|
| Raw-material oil and fat: sunflower oil | | | | Panelist | Panelist | Panelist | |
| | Sample | POV | AV | 1 | 2 | 3 | Average |
| Treatment: oxidation | Oxidized oil and fat 1 | 36.5 | — | 1 | 2 | 1 | 1.3 |
| treatment; | Oxidized oil and fat 2 | 57.1 | — | 2 | 2 | 1.5 | 1.8 |
| Amount added: 50 ppm | Oxidized oil and fat 3 | 116.0 | — | 2.5 | 3 | 2 | 2.5 |
| | Oxidized oil and fat 4 | 188.0 | — | 3 | 3.5 | 2.5 | 3.0 |

| | | | Evaluation | | | |
|---|---|---|---|---|---|---|
| Raw-material oil and fat: sunflower oil | | | Panelist | Panelist | Panelist | |
| | Sample | AV | 1 | 2 | 3 | Average |
| Treatment: oxidation | Product obtained by lipase-treating | 105.0 | 1.5 | 2 | 2.5 | 2.0 |
| and lipase treatments; | oxidized oil and fat 1 (POV: 36.5) | | | | | |
| Amount added: 50 ppm | Product obtained by lipase-treating | 96.6 | 2.5 | 3 | 3.5 | 3.0 |
| | oxidized oil and fat 2 (POV: 57.1) | | | | | |
| | Product obtained by lipase-treating | 103.1 | 3.5 | 3.5 | 3.5 | 3.5 |
| | oxidized oil and fat 3 (POV: 116.0) | | | | | |
| | Product obtained by lipase-treating | 96.3 | 4 | 4 | 4 | 4.0 |
| | oxidized oil and fat 4 (POV: 188.0) | | | | | |

As indicated by the results of the sensory evaluation in the central section in table 9, it was found that the effect for imparting a lardy consistency, more specifically the effect for imparting a lard flavor to plant-based bouillon soup, said effect being exhibited by the oxidized oils and fats obtained by implementing the prescribed oxidation treatment on sunflower oil, tended to be more prominent as the extent of oxidation increased. Additionally, as indicated by the results of the sensory evaluation in the lower section in table 9, it was found that the improved effect for imparting a lardy consistency that was achieved by furthermore implementing the lipase treatment on the oxidized oils and fats prepared using sunflower oil as a raw material also tended to be more prominent as the extent of oxidation increased.

### Test Example 5

The effect for imparting a lardy consistency to plant-based bouillon soup was examined in the same manner as in test example 1, except that the oxidized oils and fats 5 to 8 and the products obtained by lipase-treating the same, which were prepared in preparation example 2, were used as samples. The final concentration of the samples in the plant-based bouillon soup was 50 ppm, in the same manner as in test example 1.

Table 10 shows the result of the sensory evaluation.

TABLE 10
(Evaluation of lardy consistency)

| Raw-material oil and fat: macadamia nut oil | | | | Evaluation | | | |
|---|---|---|---|---|---|---|---|
| | Amount | | | Panelist | Panelist | Panelist | |
| Treatment | added | POV | AV | 1 | 2 | 3 | Average |
| Untreated | 50 ppm | — | — | 0 | 0 | 0 | 0.0 |

| | | | | Evaluation | | | |
|---|---|---|---|---|---|---|---|
| Raw-material oil and fat: macadamia nut oil | | | | Panelist | Panelist | Panelist | |
| | Sample | POV | AV | 1 | 2 | 3 | Average |
| Treatment: oxidation | Oxidized oil and fat 5 | 32.2 | — | 1 | 3 | 1.5 | 1.8 |
| treatment; | Oxidized oil and fat 6 | 60.0 | — | 2.5 | 3 | 2 | 2.5 |
| Amount added: 50 ppm | Oxidized oil and fat 7 | 108.1 | — | 3 | 3.5 | 3 | 3.2 |
| | Oxidized oil and fat 8 | 189.2 | — | 3.5 | 3.5 | 3.5 | 3.5 |

| | | | Evaluation | | | |
|---|---|---|---|---|---|---|
| Raw-material oil and fat: macadamia nut oil | | | Panelist | Panelist | Panelist | |
| | Sample | AV | 1 | 2 | 3 | Average |
| Treatment: oxidation | Product obtained by lipase-treating | 95.9 | 2 | 3 | 2 | 2.3 |
| and lipase treatments; | oxidized oil and fat 5 (POV: 32.2) | | | | | |
| Amount added: 50 ppm | Product obtained by lipase-treating | 100.4 | 3.5 | 4 | 3 | 3.5 |
| | oxidized oil and fat 6 (POV: 60.0) | | | | | |
| | Product obtained by lipase-treating | 86.9 | 4 | 4 | 4 | 4.0 |
| | oxidized oil and fat 7 (POV: 108.1) | | | | | |
| | Product obtained by lipase-treating | 93.3 | 4.5 | 4 | 4.5 | 4.3 |
| | oxidized oil and fat 8 (POV: 189.2) | | | | | |

As indicated by the results of the sensory evaluation in the central section in table 10, it was found that the effect for imparting a lardy consistency, more specifically the effect for imparting a lard flavor to plant-based bouillon soup, said effect being exhibited by the oxidized oils and fats obtained by implementing the prescribed oxidation treatment on macadamia nut oil, tended to be more prominent as the extent of oxidation increased. Additionally, as indicated by the results of the sensory evaluation in the lower section in table 10, it was found that the improved effect for imparting a lardy consistency that was achieved by furthermore implementing the lipase treatment on the oxidized oils and fats prepared using macadamia nut oil as a raw material also tended to be more prominent as the extent of oxidation increased.

### Preparation Example 3

### (1. Oxidized Oil and Fat)

A heating treatment was carried out on sunflower oil, macadamia nut oil, or coconut oil under the temperature and time conditions shown in table 11 under stirring at a stirring speed of 400 rpm. The peroxide value (POV) of the resulting oxidized oil and fat was measured in conformance with “Standard methods for the analysis of fats, oils and related materials: 2.5.2 Peroxide value.”

Table 11 shows the conditions of the oxidation treatment carried out on the oils and fats as well as the results of measuring the POV of the resulting oxidized oils and fats.

TABLE 11
(Oxidation treatment conditions)

| | | | | | | | Peroxide |
|---|---|---|---|---|---|---|---|
| Type of | | Amount | | | | Stirring | value (POV) |
| raw-material | | contained | Temperature | Time | Air flow | speed | of treated |
| oil and fat | Expression | (g) | (° C.) | (h) | (mL/min) | (rpm) | oil and fat |
| Sunflower oil | Oxidized oil | 500 | 103 | 36 | 500 | 400 | 116.0 |
| | and fat 9 | | | | | | |
| Macadamia | Oxidized oil | 450 | 103 | 29 | 450 | 400 | 108.1 |
| nut oil | and fat 10 | | | | | | |
| Coconut oil | Oxidized oil | 450 | 120 | 35 | 450 | 400 | 118.0 |
| | and fat 11 | | | | | | |

### (2. Hydrolysate)

A hydrolysis treatment carried out using a lipase was implemented on the resulting oxidized oils and fats. Specifically, 20 g of the oxidized oil and fat, 12 g of water, and the lipase (in the added amounts shown in table 12) were introduced into a 50-mL tube, the lid of the tube was closed, the tube was placed in a thermostatic oven set to 40° C., and a hydrolysis treatment carried out using the lipase was implemented under the time conditions shown in table 12 under shaking at a stirring speed of 150 rpm. After a reaction time elapsed, the tube was retrieved from the thermostatic oven and centrifuged (at 3,000 rpm for 5 min) at 24° C., and 10-15 g of an upper layer (oil layer) was harvested. The harvested treated product was introduced into a stoppered tube, dipped in an oil bath, and treated for one hour at 80° C. in order to deactivate the enzyme. The acid value of the resulting lipase-treated product was measured in conformance with “Standard methods for the analysis of fats, oils and related materials: 2.3.1 Acid value” (Japan Oil Chemists' Society).

Table 12 shows the conditions of the lipase treatment carried out on the oxidized oils and fats as well as the results of measuring the acid value of the resulting treated products.

TABLE 12
(Enzyme treatment conditions)

| | | Amount | | | |
|---|---|---|---|---|---|
| | Oxidized oil | of enzyme | | | Acid value |
| Type of raw- | and fat | added to | Temper- | | of treated |
| material | supplied to | oxidized | ature | Time | oil and |
| oil and fat | treatment | oil and fat | (° C.) | (h) | fat |
| Sunflower | Oxidized oil | 0.2% | 40 | 2.0 | 44.0 |
| oil | and fat 9 | | | | |
| | Oxidized oil | 0.2% | 40 | 5.0 | 103.1 |
| | and fat 9 | | | | |
| | Oxidized oil | 0.3% | 40 | 6.0 | 146.2 |
| | and fat 9 | | | | |
| Macadamia | Oxidized oil | 0.03% | 40 | 24.0 | 16.1 |
| nut oil | and fat 10 | | | | |
| | Oxidized oil | 0.05% | 40 | 24.0 | 40.5 |
| | and fat 10 | | | | |
| | Oxidized oil | 0.07% | 40 | 24.0 | 56.3 |
| | and fat 10 | | | | |
| | Oxidized oil | 0.1% | 40 | 24.0 | 98.3 |
| | and fat 10 | | | | |
| | Oxidized oil | 0.4% | 40 | 1.5 | 86.9 |
| | and fat 10 | | | | |
| | Oxidized oil | 0.4% | 40 | 6.0 | 130.5 |
| | and fat 10 | | | | |
| Coconut oil | Oxidized oil | 0.4% | 40 | 0.25 | 29.1 |
| | and fat 11 | | | | |
| | Oxidized oil | 0.4% | 40 | 2.5 | 67.8 |
| | and fat 11 | | | | |
| | Oxidized oil | 0.4% | 40 | 5.5 | 122.9 |
| | and fat 11 | | | | |

### Test Example 6

The effect for imparting a lardy consistency to plant-based bouillon soup was examined in the same manner as in test example 1, except that the products obtained by lipase-treating oxidized oils and fats 9 to 11, which were prepared in preparation example 3, were used as samples. The final concentration of the samples in the plant-based bouillon soup was 50 ppm, in the same manner as in test example 1.

Table 13 shows the results of the sensory evaluation.

TABLE 13
(Evaluation of lardy consistency)

| | |
|---|---|
| Raw-material oil and fat: sunflower oil | Evaluation |

| | Amount | | | Panelist | Panelist | Panelist | |
|---|---|---|---|---|---|---|---|
| Treatment | added | POV | AV | 1 | 2 | 3 | Average |
| Untreated | 50 ppm | — | — | 0 | 0 | 0 | 0.0 |
| | | | | Panelist | Panelist | Panelist | |

| | Sample | AV | 1 | 2 | 3 | Average |
|---|---|---|---|---|---|---|
| Treatment: oxidation | Product obtained by lipase-treating | 44.0 | 2.5 | 3 | 2 | 2.5 |
| and lipase treatments; | oxidized oil and fat 9 (POV: 116.0) | | | | | |
| Amount added: 50 ppm | Product obtained by lipase-treating | 103.1 | 3.5 | 3.5 | 3.5 | 3.5 |
| | oxidized oil and fat 9 (POV: 116.0) | | | | | |
| | Product obtained by lipase-treating | 146.2 | 4.5 | 3.5 | 4 | 4.0 |
| | oxidized oil and fat 9 (POV: 116.0) | | | | | |

| Raw-material oil and fat: macadamia nut oil | | | | Evaluation | | | |
|---|---|---|---|---|---|---|---|
| | Amount | | | Panelist | Panelist | Panelist | |
| Treatment | added | POV | AV | 1 | 2 | 3 | Average |
| Untreated | 50 ppm | — | — | 0 | 0 | 0 | 0.0 |
| | | | | Panelist | Panelist | Panelist | |
| | Sample | | AV | 1 | 2 | 3 | Average |
| Treatment: oxidation | Product obtained by lipase-treating | | 16.1 | 2 | 3 | 2.5 | 2.5 |
| and lipase treatments; | oxidized oil and fat 10 (POV: 108.1) | | | | | | |
| Amount added: 50 ppm | Product obtained by lipase-treating | | 40.5 | 2.5 | 3 | 3 | 2.8 |
| | oxidized oil and fat 10 (POV: 108.1) | | | | | | |
| | Product obtained by lipase-treating | | 56.3 | 3 | 3 | 3.5 | 3.2 |
| | oxidized oil and fat 10 (POV: 108.1) | | | | | | |
| | Product obtained by lipase-treating | | 98.3 | 4 | 4 | 4 | 4.0 |
| | oxidized oil and fat 10 (POV: 108.1) | | | | | | |
| | Product obtained by lipase-treating | | 130.5 | 4.5 | 4 | 4.5 | 4.3 |
| | oxidized oil and fat 10 (POV: 108.1) | | | | | | |
| Raw-material oil and fat: coconut oil | | | | Evaluation | | | |
| | Amount | | | Panelist | Panelist | Panelist | |
| Treatment | added | POV | AV | 1 | 2 | 3 | Average |
| Untreated | 50 ppm | — | — | 0 | 0 | 0 | 0.0 |
| | | | | Panelist | Panelist | Panelist | |

| | Sample | AV | 1 | 2 | 3 | Average |
|---|---|---|---|---|---|---|
| Treatment: oxidation | Product obtained by lipase-treating | 29.1 | 3 | 2.5 | 3 | 2.8 |
| and lipase treatments; | oxidized oil and fat 11 (POV: 118.0) | | | | | |
| Amount added: 50 ppm | Product obtained by lipase-treating | 67.8 | 4 | 3.5 | 4 | 3.8 |
| | oxidized oil and fat 11 (POV: 118.0) | | | | | |
| | Product obtained by lipase-treating | 122.9 | 4.5 | 3.5 | 4.5 | 4.2 |
| | oxidized oil and fat 11 (POV: 118.0) | | | | | |

As indicated by the results of the sensory evaluation in the upper section in table 13, it was found that the effect for imparting a lardy consistency, more specifically the effect for imparting a lard flavor to plant-based bouillon soup, said effect being achieved by furthermore implementing the lipase treatment on the oxidized oils and fats prepared using sunflower oil as a raw material, tended to be more prominent as the extent of acid value of the lipase-treated products increased. Additionally, as indicated by the results of the sensory evaluation in the central and lower sections in table 13, it was found that the effect for imparting a lardy consistency to plant-based bouillon soup in the same manner in cases involving oils and fats prepared using macadamia nut oil or coconut oil as a raw material also tended to be more prominent as the extent of acid value of the lipase-treated products increased.

### Test Example 7

The effect for imparting a lardy consistency to plant-based bouillon soup was examined in the same manner as in test example 1, except that the oxidized oil and fat 9 (POV: 116.0) and the product obtained by lipase-treating the same (having an acid value of 103.1), which were prepared in preparation example 3, were used as samples, and the final concentration of the samples added to the plant-based bouillon soup was set to 5, 50, 100, or 200 ppm.

Table 14 shows the results of the sensory evaluation.

TABLE 14
(Evaluation of lardy consistency)

| Raw-material oil and fat: | | | | | |
|---|---|---|---|---|---|
| sunflower oil | | Evaluation | | | |
| | Amount | Panelist | Panelist | Panelist | |
| | added | 1 | 2 | 3 | Average |
| Treatment: untreated | 5 ppm | 0 | 0 | 0 | 0.0 |
| | 50 ppm | 0 | 0 | 0 | 0.0 |
| | 100 ppm | 0 | 0 | 0 | 0.0 |
| | 200 ppm | 0 | 0 | 0 | 0.0 |
| Treatment: oxidation | 5 ppm | 1.5 | 1 | 1 | 1.2 |
| treatment; | 50 ppm | 2.5 | 3 | 2 | 2.5 |
| Oxidized oil and fat | 100 ppm | 3 | 3 | 2.5 | 2.8 |
| 9 (POV: 116.0) | 200 ppm | 3.5 | 3.5 | 3.5 | 3.5 |
| Treatment: oxidation | 5 ppm | 2.5 | 2 | 2 | 2.2 |
| and lipase treatments; | 50 ppm | 3.5 | 3.5 | 3.5 | 3.5 |
| Product (AV: 103.1) | 100 ppm | 4 | 4 | 4.5 | 4.2 |
| obtained by lipase- | 200 ppm | 4.5 | 4 | 5 | 4.5 |
| treating oxidized | | | | | |
| oil and fat 9 | | | | | |
| (POV: 116.0) | | | | | |

As indicated by the results of the sensory evaluation in the central section in table 14, it was found that the effect for imparting a lardy consistency, more specifically the effect for imparting a lard flavor to plant-based bouillon soup, said effect being exhibited by the oxidized oils and fats obtained by implementing the prescribed oxidation treatment on sunflower oil, was exhibited at a final concentration of the oxidized oil and fat in the plant-based bouillon soup within the range of 5-200 ppm. Additionally, as indicated by the results of the sensory evaluation in the lower section in table 14, it was found that the improved effect for imparting a lardy consistency that was achieved by furthermore implementing the lipase treatment on the oxidized oils and fats prepared using sunflower oil as a raw material was similarly exhibited at a final concentration of the oxidized oil and fat in the plant-based bouillon soup within the range of 5-200 ppm.

### Test Example 8

The effect for imparting a lardy consistency to plant-based bouillon soup was examined in the same manner as in test example 1, except that the oxidized oil and fat 10 (POV: 108.1) and the product obtained by lipase-treating the same (having an acid value of 86.9), which were prepared in preparation example 3, were used as samples, and the final concentration of the samples added to the plant-based bouillon soup was set to 5, 50, 100, or 200 ppm.

Table 15 shows the results of the sensory evaluation.

TABLE 15
(Evaluation of lardy consistency)

| Raw-material oil and fat: | | | | | |
|---|---|---|---|---|---|
| macadamia nut oil | | Evaluation | | | |
| | Amount | Panelist | Panelist | Panelist | |
| | added | 1 | 2 | 3 | Average |
| Treatment: untreated | 5 ppm | 0 | 0 | 0 | 0.0 |
| | 50 ppm | 0 | 0 | 0 | 0.0 |
| | 100 ppm | 0 | 0 | 0 | 0.0 |
| | 200 ppm | 0 | 0 | 0 | 0.0 |
| Treatment: oxidation | 5 ppm | 2 | 2 | 1.5 | 1.8 |
| treatment; | 50 ppm | 3 | 3.5 | 2.5 | 3.0 |
| Oxidized oil and fat | 100 ppm | 3.4 | 3.5 | 3.5 | 3.5 |
| 10 (POV: 108.1) | 200 ppm | 4 | 4 | 4 | 4.0 |
| Treatment: oxidation | 5 ppm | 3 | 2 | 3 | 2.7 |
| and lipase treatments; | 50 ppm | 4 | 4 | 4 | 4.0 |
| Product (AV: 86.9) | 100 ppm | 4.5 | 4.5 | 5 | 4.7 |
| obtained by lipase- | 200 ppm | 5 | 5 | 5 | 4.8 |
| treating oxidized | | | | | |
| oil and fat 10 | | | | | |
| (POV: 108.1) | | | | | |

As indicated by the results of the sensory evaluation in the central section in table 15, it was found that the effect for imparting a lardy consistency, more specifically the effect for imparting a lard flavor to plant-based bouillon soup, said effect being exhibited by the oxidized oils and fats obtained by implementing the prescribed oxidation treatment on macadamia nut oil, was exhibited at a final concentration of the oxidized oil and fat in the plant-based bouillon soup within the range of 5-200 ppm. Additionally, as indicated by the results of the sensory evaluation in the lower section in table 15, it was found that the improved effect for imparting a lardy consistency that was achieved by furthermore implementing the lipase treatment on the oxidized oils and fats prepared using macadamia nut oil as a raw material was similarly exhibited at a final concentration of the oxidized oil and fat in the plant-based bouillon soup within the range of 5-200 ppm.

### Test Example 9

The effect for imparting a lardy consistency to plant-based bouillon soup was examined in the same manner as in test example 1, except that the oxidized oil and fat 9 (POV: 116.0) and the product obtained by lipase-treating the same (having an acid value of 103.1), which were prepared in preparation example 3, were used as samples, and soybean oil was used as a base oil for diluting the samples (untreated oils, or various types of treated oils).

Table 16 shows the results of the sensory evaluation together with the results from when rapeseed oil was used as the base oil in test example 7.

TABLE 16

| Raw-material oil and fat: sunflower oil | | | Evaluation | | | |
|---|---|---|---|---|---|---|
| | Amount | | Panelist | Panelist | Panelist | |
| Treatment | added | Base oil | 1 | 2 | 3 | Average |
| Untreated | 50 ppm | Rapeseed oil | 0 | 0 | 0 | 0.0 |
| | | Soybean oil | 0 | 0 | 0 | 0.0 |
| Treatment: oxidation | 50 ppm | Rapeseed oil | 2.5 | 3 | 2 | 2.5 |
| treatment; | | Soybean oil | 2.5 | 3 | 2 | 2.5 |
| Oxidized oil and | | | | | | |
| fat 9 (POV: 108.1) | | | | | | |
| Treatment: oxidation | 50 ppm | Rapeseed oil | 3.5 | 3.5 | 3.5 | 3.5 |
| and lipase treatments; | | Soybean oil | 3.5 | 3.5 | 3.5 | 3.5 |
| Product (AV: 103.1) | | | | | | |
| obtained by lipase- | | | | | | |
| treating oxidized | | | | | | |
| oil and fat 9 | | | | | | |
| (POV: 116.0) | | | | | | |

As indicated by the results of the sensory evaluation in the central section in table 16, it was found that the effect for imparting a lardy consistency, more specifically the effect for imparting a lard flavor to plant-based bouillon soup, said effect being exhibited by the oxidized oils and fats obtained by implementing the prescribed oxidation treatment on sunflower oil, was exhibited even when the base oil for diluting the oxidized oil and fat to prepare the test oil to be added to the plant-based bouillon soup was switched from rapeseed oil to soybean oil. Additionally, as indicated by the results of the sensory evaluation in the lower section in table 16, it was found that the improved effect for imparting a lardy consistency that was achieved by furthermore implementing the lipase treatment on the oxidized oils and fats prepared using sunflower oil as a raw material was similarly exhibited even when the base oil for diluting the oxidized oil and fat to prepare the test oil was switched from rapeseed oil to soybean oil.

### Test Example 10

The effect of the various types of treated oils (as prepared in preparation example 1) for imparting a lardy consistency to soy burgers was evaluated. Specifically, first, the various types of treated oils derived from macadamia nut oil or sunflower oil (six types of treated oils prepared in preparation example 1) were used in the blends shown in table 17 to prepare soy burgers. Additionally, soy burgers obtained using rapeseed oil or lard were also prepared for use as controls in the sensory evaluation.

### Preparation of Soy Burgers

(1) Add water to soybean protein
(2) Mix together all ingredients
(3) Mold resulting article and then cook at 180° C. for one minute and thirty seconds per side in a frying pan

TABLE 17
(Soy burgers)

| | | Control | Control | Test |
|---|---|---|---|---|
| | | example 1 | example 2 | example |
| Raw | Soybean protein 1* | 10 | 10 | 10 |
| material | Soybean protein 2** | 10 | 10 | 10 |
| (mass %) | Water (for addition to | 43 | 43 | 43 |
| | soybean protein) | | | |
| | Black pepper | 0.1 | 0.1 | 0.1 |
| | Table salt | 0.7 | 0.7 | 0.7 |
| | Granulated sugar | 0.7 | 0.7 | 0.7 |
| | Monosodium glutamate | 0.5 | 0.5 | 0.5 |
| | Sautéed onions | 12 | 12 | 12 |
| | Shortening | 15 | 15 | 15 |
| | Dried egg whites | 6 | 6 | 6 |
| | Rapeseed oil | 2 | — | — |
| | Lard | — | 2 | — |
| | Test oil (any of six types | — | — | 2 |
| | prepared in test example 1) | | | |

| | | | |
|---|---|---|---|
| Total | 100 | 100 | 100 |

Soybean protein 1*: Plantxt M-14, made by J-Oil Mills, Inc.
Soybean protein 2**: Plantxt F-16, made by J-Oil Mills, Inc.

The prepared soy burgers were rated using the scoring criteria below by three expert panelists in a comparison with a product obtained when rapeseed oil or lard was used as a control, and an average value of the scores for the soy burgers was derived. Additionally, representative comments from the panelists were gathered.

### (Samples).

Untreated: Oil and fat prior to oxidation treatment.
Oxidation treatment: Oil and fat after oxidation treatment.
Oxidation and lipase treatments: Oil and fat obtained by furthermore implementing lipase treatment on oxidized oil and fat

### (Scores)

0: No taste (equivalent to rapeseed oil)
1: Very weak taste
2: Weak taste
3: Moderate taste
4: Strong taste
5: Very strong taste (equivalent to lard)
(Scored at intervals of 0.5 points in cases involving intermediate evaluations between the abovementioned scores)

Table 18 shows the results of scoring in the sensory evaluation as well as results for the representative comments from the panelists.

TABLE 18
(Evaluation of lardy consistency in soy burgers)

| Test oils | | Evaluation | | | | |
|---|---|---|---|---|---|---|
| Raw-material | | Panelist | Panelist | Panelist | | |
| oil and fat | Treatment | 1 | 2 | 3 | Average | Comments |
| Macadamia | Untreated | 0 | 0 | 0 | 0.0 | Tastes plain and has little richness |
| nut oil | Oxidation treatment | 3 | 2 | 2.5 | 2.5 | Has moderate sweet fatty richness |
| | | | | | | similar to that of lard |
| | Oxidation and | 4 | 4 | 3.5 | 3.8 | Has sweet fatty richness and depth |
| | lipase treatments | | | | | of flavor similar to those of lard |
| Sunflower oil | Untreated | 0 | 0 | 0 | 0.0 | Tastes plain and has little richness |
| | Oxidation treatment | 3.5 | 4 | 3 | 3.5 | Has moderate sweet fatty richness |
| | | | | | | similar to that of lard |
| | Oxidation and | 4.5 | 5 | 4 | 4.5 | Has sweet fatty richness and fatty |
| | lipase treatments | | | | | consistency similar to those of lard |

| | | | |
|---|---|---|---|
| Control 1 | Rapeseed oil | — | Tastes plain and has little richness |
| Control 2 | Lard | — | Has sweet richness, fragrance, depth |
| | | | of flavor, and fatty consistency |

As indicated by the results of the sensory evaluation in the upper sections for each of the oils and fats in table 18, adding the untreated oils and fats did not yield an effect for imparting a lardy consistency to soy burgers. However, as indicated by the results of the sensory evaluation in the central sections for each of the oils and fats in table 18, it was clarified that the oxidized oils and fats obtained by implementing the prescribed oxidation treatment have an effect for imparting a lardy consistency, more specifically an effect for imparting a lardy consistency to soy burgers prepared without using meat. Additionally, as indicated by the results of the sensory evaluation in the lower sections for each of the oils and fats in table 18, it was clarified that furthermore implementing the lipase treatment on the oxidized oils and fats prepared using the oils and fats as raw materials further improved the effect for imparting a lardy consistency to soy burgers prepared without using meat over the effect of the oxidized oils and fats that were subjected to only the oxidation treatment.

### Test Example 11

The effect of the various types of treated oils (as prepared in preparation example 1) for imparting a chicken-oil consistency to soy nuggets was evaluated. Specifically, first, the various types of treated oils derived from macadamia nut oil or sunflower oil (six types of treated oils prepared in preparation example 1) were used in the blends shown in table 19 to prepare soy nuggets. Additionally, soy nuggets obtained using rapeseed oil or chicken oil were also prepared for use as controls in the sensory evaluation.

### Preparation of Soy Nuggets

(1) Add water to soybean protein
(2) Mix all ingredients in food processor
(3) Mold resulting article, batter with tempura powder dissolved in water, and then fry in oil at 170° C.

TABLE 19
(Soy nuggets)

| | | Control | Control | Test |
|---|---|---|---|---|
| | | example 1 | example 2 | example |
| Raw | Soybean protein 1* | 7 | 7 | 7 |
| material | Soybean protein 2** | 10 | 10 | 10 |
| (mass %) | Water (for addition to | 63 | 63 | 63 |
| | soybean protein) | | | |
| | Table salt | 1 | 1 | 1 |
| | Dried egg whites | 5 | 5 | 5 |
| | Granulated sugar | 1.3 | 1.3 | 1.3 |
| | Black pepper | 0.2 | 0.2 | 0.2 |
| | Monosodium glutamate | 0.5 | 0.5 | 0.5 |
| | Shortening | 10 | 10 | 10 |
| | Rapeseed oil | 2 | — | — |
| | Chicken oil | — | 2 | — |
| | Test oil (any of six types | — | — | 2 |
| | prepared in test example 1) | | | |

| | | | |
|---|---|---|---|
| Total | 100 | 100 | 100 |

Soybean protein 1*: Apex 110, made by Fuji Oil Co., Ltd.
Soybean protein 2**: Apex 950, made by Fuji Oil Co., Ltd.

The prepared soy nuggets were rated using the scoring criteria below by three expert panelists in a comparison with a product obtained when rapeseed oil or chicken oil was used as a control, and an average value of the scores for the soy nuggets was derived. Additionally, representative comments from the panelists were gathered.

### (Samples)

Untreated: Oil and fat prior to oxidation treatment.
Oxidation treatment: Oil and fat after oxidation treatment.
Oxidation and lipase treatments: Oil and fat obtained by furthermore implementing lipase treatment on oxidized oil and fat

### (Scores)

0: No taste (equivalent to rapeseed oil)
1: Very weak taste
2: Weak taste
3: Moderate taste
4: Strong taste
5: Very strong taste (equivalent to chicken oil)
(Scored at intervals of 0.5 points in cases involving intermediate evaluations between the abovementioned scores)

Table 20 shows the results of scoring in the sensory evaluation as well as results for the representative comments from the panelists.

TABLE 20
(Evaluation of chiken-oil consistency in soy nuggets)

| Test oils | | Evaluation | | | | |
|---|---|---|---|---|---|---|
| Raw-material | | Panelist | Panelist | Panelist | | |
| oil and fat | Treatment | 1 | 2 | 3 | Average | Comments |
| Macadamia | Untreated | 0 | 0 | 0 | 0.0 | Tastes plain and has little richness |
| nut oil | Oxidation treatment | 3 | 2 | 3 | 2.7 | Has sweetness similar to that of |
| | | | | | | chicken oil |
| | Oxidation and | 4 | 3 | 4 | 3.7 | Has richness and sweetness similar |
| | lipase treatments | | | | | to those of chicken oil |
| Sunflower oil | Untreated | 0 | 0 | 0 | 0.0 | Tastes plain and has little richness |
| | Oxidation treatment | 2.5 | 2 | 3 | 2.5 | Has richness similar to that of |
| | | | | | | chicken oil |
| | Oxidation and | 4 | 3 | 4 | 3.7 | Has richness and oily consistency |
| | lipase treatments | | | | | similar to those of chicken oil |

| | | | |
|---|---|---|---|
| Control 1 | Rapeseed oil | — | Tastes plain and has little richness |
| Control 2 | Chicken oil | — | Has sweet richness and juicy, oily |
| | | | consistency |

As indicated by the results of the sensory evaluation in the upper sections for each of the oils and fats in table 20, adding the untreated oils and fats did not yield an effect for imparting a chicken-oil consistency to soy nuggets. However, as indicated by the results of the sensory evaluation in the central sections for each of the oils and fats in table 20, it was clarified that the oxidized oils and fats obtained by implementing the prescribed oxidation treatment have an effect for imparting a chicken-oil consistency, more specifically an effect for imparting a chicken-oil consistency to soy nuggets prepared without using meat. Additionally, as indicated by the results of the sensory evaluation in the lower sections for each of the oils and fats in table 20, it was clarified that furthermore implementing the lipase treatment on the oxidized oils and fats prepared using the oils and fats as raw materials further improved the effect for imparting a chicken-oil consistency to soy nuggets prepared without using meat over the effect of the oxidized oils and fats that were subjected to only the oxidation treatment.

1. A method for imparting an animal-fat consistency, comprising:
incorporating an agent for imparting an animal-fat consistency into a food product, the agent comprising an oxidized oil and fat that is not derived from animals as an active ingredient.

2. The method for imparting an animal-fat consistency according to claim 1, wherein the oxidized oil and fat is obtained by oxidizing at least one oil and fat selected from rapeseed oil, soybean oil, sunflower oil, rice bran oil, corn oil, red palm oil, grapeseed oil, macadamia nut oil, and coconut oil.

3. A method for imparting an animal-fat consistency, comprising:
incorporating an agent for imparting an animal-fat consistency into a food product, the agent comprising a product obtained by enzymatically hydrolyzing an oxidized oil and fat that is not derived from animals as an active ingredient.

4. The method for imparting an animal-fat consistency according to claim 3, wherein the oxidized oil and fat is obtained by oxidizing at least one oil and fat selected from rapeseed oil, soybean oil, sunflower oil, rice bran oil, corn oil, red palm oil, grapeseed oil, macadamia nut oil, and coconut oil.

5. A method for imparting an animal-fat consistency, comprising:
incorporating an oil and fat composition for imparting an animal-fat consistency into a food product, the oil and fat composition comprising an edible oil and fat that serves as a base oil, and an oxidized oil and fat that is not derived from animals.

6. The method for imparting an animal-fat consistency according to claim 5, wherein the oxidized oil and fat is obtained by oxidizing at least one oil and fat selected from rapeseed oil, soybean oil, sunflower oil, rice bran oil, corn oil, red palm oil, grapeseed oil, macadamia nut oil, and coconut oil.

7. A method for imparting an animal-fat consistency, comprising:
incorporating an oil and fat composition for imparting an animal-fat consistency into a food product, the oil and fat composition comprising an edible oil and fat that serves as a base oil, and a product obtained by enzymatically hydrolyzing an oxidized oil and fat that is not derived from animals.

8. The method for imparting an animal-fat consistency according to claim 7, wherein the oxidized oil and fat is obtained by oxidizing at least one oil and fat selected from rapeseed oil, soybean oil, sunflower oil, rice bran oil, corn oil, red palm oil, grapeseed oil, macadamia nut oil, and coconut oil.

9. (canceled)

10. The method for imparting an animal-fat consistency according to claim 19, wherein the agent for imparting an animal-fat consistency is incorporated such that the amount of the oxidized oil and fat that is not derived from animals is 0.0001 parts by mass or greater and 10 parts by mass or less per 100 parts by mass of the food product.

11. The method for imparting an animal-fat consistency according to claim 3, wherein the agent for imparting an animal-fat consistency is incorporated such that the amount of the product obtained by enzymatically hydrolyzing an oxidized oil and fat that is not derived from animals is 0.0001 parts by mass or greater and 10 parts by mass or less per 100 parts by mass of the food product.

12.-23. (canceled)

24. The method for imparting an animal-fat consistency according to claim 5, wherein the oil and fat composition for imparting an animal-fat consistency is incorporated such that the amount of the oxidized oil and fat that is not derived from animals is 0.0001 parts by mass or greater and 10 parts by mass or less per 100 parts by mass of the food product.

25. The method for imparting an animal-fat consistency according to claim 7, wherein the oil and fat composition for imparting an animal-fat consistency is incorporated such that the amount of the product obtained by enzymatically hydrolyzing an oxidized oil and fat that is not derived from animals is 0.0001 parts by mass or greater and 10 parts by mass or less per 100 parts by mass of the food product.

26. The method for imparting an animal-fat consistency according to claim 1, wherein the food product is a processed-meat-like food product that does not contain any meat raw materials, a processed-meat food product, or a processed-meat-stock-soup-like food product.

27. The method for imparting an animal-fat consistency according to claim 3, wherein the food product is a processed-meat-like food product that does not contain any meat raw materials, a processed-meat food product, or a processed-meat-stock-soup-like food product.

28. The method for imparting an animal-fat consistency according to claim 5, wherein the food product is a processed-meat-like food product that does not contain any meat raw materials, a processed-meat food product, or a processed-meat-stock-soup-like food product.

29. The method for imparting an animal-fat consistency according to claim 7, wherein the food product is a processed-meat-like food product that does not contain any meat raw materials, a processed-meat food product, or a processed-meat-stock-soup-like food product.
